(19) United States
(12) Patent Application Publication
(10) Pub. No.: US 2023/0275536 A1
(43) Pub. Date: Aug. 31, 2023

(54) ENERGY SYSTEM AND METHOD, AND DATA CARRIER COMPRISING INSTRUCTIONS THEREFOR

(71) Applicant: VIRIDI HOLDING B.V., Hengelo (NL)

(72) Inventor: Nicolaas Johannes VISSER, Nijkerk (NL)

(73) Assignee: VIRIDI HOLDING B.V., Nengelo (NL)

(21) Appl. No.: 17/766,975

(22) PCT Filed: Oct. 13, 2020
(86) PCT No.: PCT/NL2020/050630

§ 371 Date: Apr. 6, 2022

(30) Foreign Application Priority Data
Oct. 18, 2019 (NL) 2024043

(51) Int. Cl. H02S 10/20; F24D 11/02; F24S 80/30; F24S 10/80; H02S 40/42

(52) U.S. Cl. CPC H02S 10/20; F24D 11/0221; F24S 10/80; F24S 80/30; H02S 40/425; F24S 60/30

(57) ABSTRACT

A system including a photovoltaic panel having a first heat exchanger for absorbing heat from the panel and/or from the environment by a heat exchanging fluid, connected to a heat pump. A second heat exchanger is provided for absorbing heat by the heat exchanging fluid and a control means for controlling a flow of the heat exchanging fluid through the first heat exchanger and/or the second heat exchanger. The heat pump is arranged to cool the heat exchanging fluid. The system has the following operating modes: a first mode in which cooled heat exchanging fluid is fed to the first heat exchanger; and a second mode in which cooled heat exchanging fluid is fed to the second heat exchanger and then fed to the first heat exchanger.

The invention relates to a system. In particular the invention relates to an energy system.

The system according to the invention comprises:
at least one photovoltaic panel having at least one first heat exchanger for absorbing heat from said panel and/or from the environment by a heat exchanging fluid, said at least one first heat exchanger having an inlet for feeding heat exchanging fluid thereto and an outlet for discharging heat exchanging fluid therefrom;
a heat pump having an inlet connected to the outlet of the at least one first heat exchanger for receiving heat exchanging fluid from the outlet of the at least one first heat exchanger via a first conduit and an outlet connected to the inlet of the at least one first heat exchanger for feeding heat exchanging fluid to the at least one first heat exchanger via a second conduit;
a third conduit connecting the second conduit to a second heat exchanger for absorbing heat by the heat exchanging fluid;
a control means for controlling a flow of the heat exchanging fluid trough the first conduit and/or the second conduit and/or the third conduit,
   wherein said heat pump is arranged to discharge heat from the heat exchanging fluid, thereby cooling the heat exchanging fluid, the system having at least the following operating modi:
a first mode wherein at least a part of said cooled heat exchanging fluid is fed to the at least one first heat exchanger via the second conduit; and
a second mode, wherein at least a part of said cooled heat exchanging fluid is fed to the second heat exchanger via said third conduit and then fed to the inlet of the at least one first heat exchanger.

In accordance with the invention the heat pump is arranged to discharge heat from the heat exchanging fluid, such that the temperature of the heat exchanging fluid decreases while flowing through the heat pump. In particular, the heat exchanging fluid may be in heat exchanging contact with an evaporator of the heat pump, wherein a fluid that evaporates in the evaporator discharges heat from the heat exchanging fluid in its evaporation process.

In the first mode, the heat exchanging fluid that is cooled by the heat pump is fed to the at least one first heat exchanger directly, i.e. without passing the second heat exchanger, and may cool the at least one photovoltaic panel, such that the efficiency of the photovoltaic panel may increase.

In the second mode, the heat exchanging fluid that is cooled by the heat pump first passes the second heat exchanger prior to being fed to the first heat exchanger. The second heat exchanger may be a heat exchanger arranged in, at or near a building, and may be used for cooling said building, for instance by having a second heat exchanging fluid that is cooled by the heat exchanging fluid and thereby able to cool the building, for example via an air conditioning system. The heat exchanging fluid increases in temperature in the second heat exchanger, but may still be cold enough to cool the at least one photovoltaic panel, such that the efficiency of the photovoltaic panel may increase.

The applicant has found that said system according to the invention is unexpectedly able to both cool a building via the second heat exchanger and cool the at least one photovoltaic panel, by having the heat pump that cools down the heat exchanging fluid.

It is noted that the heat pump is arranged to discharge heat in order to cool the heat exchanging fluid. The heat pump may therefore be in thermal exchange with any sort of cold body acting as a cold buffer.

It is noted that said system can be operated in the second mode in particular at relatively high outside temperatures, when cooling of the building is preferred. If no cooling of the building is required, for example at lower outside temperatures, the system may be operated in the first mode. For example in a winter period the system may be operated in the first mode. Even at relatively low outside temperatures the heat exchanging fluid may still be able to absorb some heat from the environment via the first heat exchanger, which heat the heat pump is able to absorb via the evaporator and which may be used for heating said building or tap water to be supplied to said building. In such a mode the first heat exchanger may be seen as a heat source for the heat pump.

The system may be switchable between the first and second operating modi.

It is noted, that said system may have any further desired operating modi and is not limited to the first mode and/or second mode as described above. The heat pump, and in particular the evaporator thereof, is practically able to cool down the heat exchanging fluid by for example approximately 5° C. Therefore, in order to be able to cool down the building in the second mode, the temperature of the heat exchanging fluid should not increase too much in the first and/or second heat exchanger. More in particular, for a relatively warm day the temperature of the heat exchanging fluid may preferably be between approximately 12 - 15° C. directly downstream of the heat pump and prior to being fed to the second heat exchanger, and the temperature of the heat exchanging fluid may preferably be between approximately 17 - 20° C. directly upstream of the heat pump. For a relatively cool day, these temperatures may be lower. The invention therefore also relates to controlling the flow of heat exchanging fluid such that these or other suitable temperature requirements may be met.

In accordance with an aspect of the invention, said system comprises at least two of said photovoltaic panels, each photovoltaic panel having a said first heat exchanger having a said inlet and a said outlet, and wherein, at least in the second mode of the system, the system is switchable between a first configuration wherein said control means are arranged to feed heat exchanging fluid to all of the first heat exchangers and a second configuration wherein said control means are arranged to feed heat exchanging fluid to some, but not all, of the first heat exchangers.

By feeding heat exchanging fluid to some, but not all, of the first heat exchangers in the second configuration, the temperature increase of the heat exchanging fluid may be limited, such that for example the above described or other temperature requirements may be met.

The number of first heat exchangers to which heat exchanging is fed and the remaining number of first heat exchangers to which no heat exchanging is fed may be suitably chosen, for example in such a manner that the above described temperature differences or other temperature requirements are met.

It is noted that by not feeding the heat exchanging fluid to some of the first heat exchangers, the respective photovoltaic panels thereof are not cooled. This may reduce the efficiency thereof, but the advantage of being able to cool the building and to cool the other photovoltaic panels may outweigh this disadvantage.

It is further noted that it may be possible in for example a further operating mode that no heat exchanging fluid is fed to any of the first heat exchangers, i.e. in such a further operating mode the control means may be arranged to feed heat exchanging fluid to none of the first heat exchangers, i.e. all first heat exchangers are bypassed.

Additionally or alternatively said system may comprise a first heat exchanger bypass conduit that connects the second conduit to the first conduit and at least one controllable three-way valve connecting the first heat exchanger bypass conduit to the second conduit and/or the first conduit.

The first heat exchanger bypass conduit and the at least one controllable three-way valve allows the heat exchanging fluid that flows through the second conduit to be directed towards the remainder of the second conduit, towards the first heat exchanger bypass conduit, or towards both. In other words, in this embodiment of the system is it possible for all or some of the heat exchanging fluid to bypass the first exchanger (s), thereby being able to limit the temperature increase of the heat exchanging fluid and/or to be able to meet the above described or other temperature requirements and/or to be able to bypass the first heat exchanger(s) for any other desired reason.

The first heat exchanger bypass conduit may connect to the first conduit at any desired location, such as for example downstream of the first heat exchanger(s).

The first heat exchanger bypass conduit may connect to the second conduit at any desired location, such as for example downstream of the second heat exchanger and upstream of the first heat exchanger(s), more in particular for example directly upstream of the first heat exchanger, wherein directly may be understood here to mean that no other heat exchangers are bypassed except for the first heat exchanger(s). As an alternative example, the first heat exchanger bypass conduit may connect to the second conduit upstream of both the second heat exchanger and the first heat exchanger(s), such that also the second heat exchanger may be bypassed by the first heat exchanger bypass conduit. In this embodiment, the at least one controllable three-way valve may be operatively connected to the control means, so that the control means can control the at least one controllable three-way valve.

The first heat exchanger bypass conduit may be arranged at the same side of the heat pump as the first heat exchangers. The first heat exchanger bypass conduit may form a circuit on that side of the heat pump that is free om other active components, such as heat exchangers. As a result, the amount of fluid running through the first heat exchanger bypass conduit can suitable be controlled by e.g. the three way valve.

In stead of completely bypassing one or more of the first heat exchangers, the control means may be configured, in a particular operating mode, to reduce the amount of heat exchanging fluid running through one or more of the first heat exchangers, by instead flowing more heat exchanging fluid through the first heat exchanger bypass conduit. Accordingly, the control means may be configured to mix heat exchanging fluid from one or more first heat exchangers with heat exchanging fluid from the first heat exchanger bypass conduit, to obtain heat exchanging fluid with a desirable temperature. To achieve the desirable temperature, the control means may be configured to choose a flow rate of heat exchanging fluid through every first heat exchanger and through the first heat exchanger bypass conduit.

It is further noted that the control means may be configured to determine the flow rate of heat exchanging fluid by controlling a pump provided for circulating the heat exchanging fluid.

Choosing the number of first heat exchangers to which heat exchanging fluid will flow and/or a flow rate of the heat exchanging fluid that returns to the heat pump via the first heat exchanger bypass conduit, for example to be able to meet the above described or other temperature requirements, and thereby controlling the heat exchanging fluid flow accordingly by the control means, may be based on a chosen parameter or condition.

For example, said control means may be arranged to feed heat exchanging fluid to some, but not all, of the first heat exchangers and/or to at least partly return to the heat pump via the first heat exchanger bypass conduit based on at least one of the following:
a temperature of the heat exchanging fluid, for example:
   at or downstream of the outlet of the heat pump;
   at or upstream of the inlet of the at least one first heat exchanger;
   at or downstream of the outlet of the at least one first heat exchanger,
the ambient temperature.

Based on the temperature of the heat exchanging fluid at any of the above described or other suitable location, it is possible to determine in a feedback loop whether the temperature of the heat exchanging fluid is maintained within the above described or other temperature range and/or whether the capacity of the heat pump is in equilibrium with the heat absorption in the first and/or second heat exchanger(s). For example in the second mode, if it is determined that the temperature of the heat exchanging fluid increases, the number of first heat exchangers to which the heat exchanging fluid is fed may be reduced and/or the flow rate of the heat exchanging fluid that returns to the heat pump via the first heat exchanger bypass conduit may be increased. For example in the second mode, if it is determined that the temperature of the heat exchanging fluid decreases, the number of first heat exchangers to which the heat exchanging fluid is fed may be increased and/or the flow rate of the heat exchanging fluid that returns to the heat pump via the first heat exchanger bypass conduit may be decreased. For example in the second mode, if it is determined that the temperature of the heat exchanging fluid does substantially not change and/or is within a suitable range, the number of first heat exchangers to which the heat exchanging fluid is fed may be maintained and/or the flow rate of the heat exchanging fluid that returns to the heat pump via the first heat exchanger bypass may be maintained.

Additionally or alternatively is it possible to control the heat exchanging fluid flow based on the ambient temperature, i.e. an outside temperature outside of the building that is cooled by the system according to the invention. In such an embodiment it is advantageous if a database containing information about the components of the system is available, such that control of the heat exchanging fluid flow and thereby control of the number of first heat exchangers to which the heat exchanging fluid is fed and/or the flow rate of the heat exchanging fluid that returns to the heat pump via the first heat exchanger bypass conduit, may be arranged based on the ambient temperature and the database of information. This allows for a simple control of the system.

In the above described embodiment said system may comprise one or more temperature sensors for measuring any one or more of the described temperature. In particular, any one or more temperature sensors may be arranged for measuring the temperature of the heat exchanging fluid, for example at any of the described or other location, and/or for measuring the ambient temperature. In stead of measuring the ambient temperature, it may be retrieved from a weather service.

Additionally or alternatively, said control means may be arranged to feed heat exchanging fluid to some, but not all, of the first heat exchangers and/or to at least partly return to the heat pump via the first heat exchanger bypass conduit based on at least one of the following:
a cooling capacity of the heat pump;
heat absorption of the heat exchanging fluid in the second heat exchanger, and
heat absorption the heat exchanging fluid in the respective first heat exchangers.

Said cooling capacity and heat absorption can be stored in a database containing such and possibly other information about the systems and/or components thereof. Based on this information, the heat exchanging fluid flow can be controlled by the control means.

The control means may be connected to the database for retrieving said information. Furthermore the control means may be able to add information to the database and/or change information in the database, in order to fill the database with system parameters and/or response characteristics during use of the system.

This embodiment of the system may work particularly advantageously in combination with the previously described embodiment in which the ambient temperature is measured.

In yet another embodiment of the system according to the invention said system further comprises at least one first controllable valve between the outlet of each one or multiple of the first heat exchangers and the first conduit and/or between the second conduit and the inlet of each of the one or multiple first heat exchangers, the first controllable valves being operatively connected to the control means, wherein the control means are arranged for adjusting the first controllable valves independently from each other between an open and a closed position to control the flow of heat exchanging fluid through the respective one or multiple first heat exchangers.

Choosing the number of first heat exchangers to which heat exchanging fluid is fed may easily be controlled by said above described first controllable valves.

If the heat exchanging fluid is not fed to all first heat exchangers and/or if not all heat exchanging fluid is fed to first heat exchangers, a remainder of the heat exchanging fluid may for example flow through said above described first heat exchanger bypass conduit.

In yet another embodiment of the system according to the invention said system further comprises a fourth conduit connecting the first conduit to a third heat exchanger for discharging heat from the heat exchanging fluid, wherein at least in the second mode substantially no heat exchanging fluid is fed to the third heat exchanger via the fourth conduit, and in a third mode of the system at least a part of the heat exchanging fluid is fed to the third heat exchanger via the fourth conduit,

wherein preferably the fourth conduit is connected to the first conduit via a second controllable three-way valve which is operatively connected to the control means, wherein the control means are arranged for adjusting the second controllable three-way valve between an open and a closed position to control the flow of heat exchanging fluid through the fourth conduit. Alternatively or additionally the second controllable valve may be placed downstream of the third heat exchanger.

The system according to the invention may be operated in said described third mode, wherein at least a part of the heat exchanging fluid is fed to the third heat exchanger via the fourth conduit. Said third heat exchanger may be a heat exchanger of the building and may be arranged for heating tap water by absorbing heat from the heat exchanging fluid, either directly or indirectly via a further heat exchanging fluid. Alternatively or additionally the third heat exchanger may be used to discharge heat to a buffer as described below. This third mode may be advantageous if the temperature increase of the heat exchanging fluid in the first heat exchanger(s) is large enough for the heat exchanging fluid to heat the tap water via the third heat exchanger.

In the third mode it may be advantageous if the heat exchanging fluid is fed to all first heat exchangers, if more than one first heat exchanger is provided.

The third mode may for example be temporarily activated when tap water is tapped by a user.

It is noted that said fourth conduit in particular connects to the first conduit upstream of the heat pump.

It is further noted that after passing said third heat exchanger the fourth conduit may connect to the second conduit, preferably downstream of the third conduit and upstream of the first heat exchanger(s).

It is further noted that said second controllable three-way valve may be a mixing valve.

The system may be switchable between the first, second, third, and any other further operating modi.

In yet another embodiment of the system according to the invention said heat pump is configured to be at least partly powered by electrical energy generated by said at least one photovoltaic panel.

It is noted that all electrical energy required for driving the heat pump and in particular the compressor thereof may be provided by the at least one photovoltaic panel, or some of the required electrical energy while the remainder of the electrical energy required may be provided by an external source of electricity, such as an electricity grid, or, for example in case no electrical energy is generated by said at least one photovoltaic panel, all electrical energy required may be provided by the external source of electricity, such as the electricity grid.

In yet another embodiment of the system according to the invention said system further comprises a heat buffer for storing heat, wherein said heat pump is arranged to heat the heat buffer.

Said heat buffer may for instance be a boiler.

Practically the heat buffer comprises a container with an inlet for filling it with a heat buffer fluid and an outlet for discharging heat buffer fluid from the container. The heat buffer fluid may be water.

The heat buffer may additionally be connected via the above-described third heat exchanger, so that the heat buffer may absorb heat from one or more first heat exchangers via heat exchanging fluid flowing through the first conduit and through the fourth conduit.

The heat that is discharged from the heat exchanging fluid by the heat pump may be stored in the heat buffer. Said heat buffer may be used for heating the building and/or tap water for the building. Alternatively or additionally the buffer may contain (tap)water. If the buffer contains tap water, this water may be used directly as a source of heated water, or it may be used to heat other tap water so that it is used indirectly. A fifth conduit may be provided, either connected to the outlet of the heat buffer for letting out heated heat buffer fluid, or in heat exchanging contact with the heat buffer fluid to heat fluids flowing through the fifth conduit. The fifth conduit may also be advantageous for other heat buffer fluids than (tap) water. The fifth conduit may connect to a heating or tap water system of the building.

Such a heat buffer may be particularly advantageous when the absorbed heat by the heat exchanging fluid is relatively high, since in those circumstances a relatively large amount of heat needs to be absorbed by the heat buffer as well. Consequently, the heat buffer could be filled via the inlet with a cold buffer fluid, such as cold tap water, which could then be heated by the heat pump. When the buffer fluid is heated to such an extend that the heat pump can no longer heat it, a situation which may occur at a buffer fluid temperature of approximately 60° C., it may be required to cool the heat buffer fluid, in order to still be able to cool said at least one photovoltaic panel via the first heat exchanger(s). Cooling the heat buffer fluid may for example be obtained by running the heated buffer fluid through a cooling circuit, for instance installed in the earth or foundation of a building, or if a system is provided as described directly below, having said fourth mode.

In another embodiment of the system according to the invention, in a fourth mode of the system, at least part of the heat exchanging fluid is fed to the at least one first heat exchanger via the second conduit and the heat pump is arranged to heat the heat exchanging fluid, thereby discharging heat from a heat pump fluid and thus cooling the heat pump fluid, and at least one of the following:
a fourth heat exchanger is provided, wherein said cooled heat pump fluid is arranged for cooling central heating system fluid in said fourth heat exchanger, and
a or said heat buffer fluid is cooled by the cooled heat pump fluid.

In this fourth mode the heat pump is thus used in a reversed mode as compared to at least the first and second mode.

The fourth mode may for example be advantageous if a building is to be cooled during the night, such that the building may be cooled via the fourth heat exchanger, and wherein the heat exchanging fluid is able to discharge its heat via the first heat exchanger(s) which is/are located outside of the building in the cool night and thereby able to cool the heat exchanging fluid, such that after being cooled in the first heat exchanger(s) the heat exchanging fluid is able to absorb heat from the heat pump fluid in the heat pump. In this case said buffer may be bypassed.

Alternatively or additionally the fourth mode may for example be advantageously used to cool down a or said heat buffer fluid during the night. As described above, the heat exchanging fluid is able to discharge its heat via the first heat exchanger(s) which is/are located outside of the building in the cold night, such that after being cooled in the first heat exchanger(s) the heat exchanging fluid is able to absorb heat in the heat pump from the heat pump fluid, such that a or said heat buffer fluid may be cooled by the cooled heat pump fluid. Said heat buffer fluid may the heat buffer fluid contained in the heat buffer as described above, or of a second heat buffer.

In a practical embodiment of the system according to the invention said system further comprises at least one pump arranged for pumping the heat exchanging fluid through the first and/or second and/or third and/or fourth conduit, wherein the control means are operatively connected to the pump for controlling the flow of heat exchanging fluid caused by the pump. Multiple pumps may be present for controlling the flow through each or several conduits separately.

In yet another embodiment of the system according to the invention, the at least one first heat exchanger comprises a three dimensional fabric, the three dimensional fabric comprising two woven or knitted main surfaces which extend substantially parallel to each other at a distance from each other, wherein the main surfaces are interconnected by a plurality of piles, wherein said plurality of piles defines a plurality of flow paths therebetween between the inlet and outlet of the at least one first heat exchanger.

Such a heat exchanger was found to allow a relatively high and uniform heat transfer. It is therefore particularly suitable for absorbing heat from photovoltaic panels. It is believed the plurality of flow paths, which may merge and split repeatedly due to the piles, may cause a heat exchanging fluid flowing from the inlet to the outlet to follow a rather chaotic or even turbulent flow. Without wishing to be bound by theory, the applicant believes this chaotic or turbulent flow contributes to the relatively high heat transfer capacity for the first heat exchanger.

Said piles may in particular be pile threads, made of any suitable material.

Said piles may be provided during weaving or knitting of the main surfaces and/or be part of the woven or knitted structure, in particular by directly weaving the piles together with the main surfaces.

Said piles may extend substantially orthogonal, or at a non-zero angle, with respect to and between the main surfaces. Said piles may be straight or curved.

Said main surfaces and/or piles may be made of any suitable material. The piles may be made of the same or a different material as the main surfaces. Practically at least part of the piles can be made of a heat conducting material, thereby enhancing an heat transfer from the piles to the heat exchanging fluid. For example said piles may be made of copper, aluminum or stainless steel.

Practically at least one of the two main surfaces may be fluid impermeable. This may for example be obtained by applying a fluid impermeable coating or layer to at least one of the two main surfaces.

Said three dimensional fabric may be arranged in a fluid impermeable casing. Said casing may for example enclose at least part of a circumferential edge of the fabric and/or at least one of the main surfaces.

The invention also relates to a method for absorbing heat from at least one photovoltaic panel and/or from the environment by a heat exchanging fluid, the photovoltaic panel having at least one first heat exchanger, the method comprising:
a) running the heat exchanging fluid through the at least one first heat exchanger, so that it absorbs heat from its respective photovoltaic panel and/or from the environment; and
b) running the heat exchanging fluid through a heat pump, and discharging heat from the heat exchanging fluid by the heat pump, thereby cooling the heat exchanging fluid,
c) switching between:
   a first mode of the method, wherein steps a) and b) are repeated and/or continuously conducted; and
   a second mode of the method, wherein steps a) and b) are repeated and/or continuously conducted and the method further comprises running the cooled heat exchanging fluid through a second heat exchanger.

The method may be performed using the system as described above, having any combination of characteristics.

Such a method has the advantage that in the first mode, the at least one photovoltaic panel is cooled, which enhances its efficiency in converting light to electricity. Furthermore, the first heat exchanger may be used to collect heat, the first heat exchanger thus forming a heat source for the heat pump. In the second mode, the method may offer the advantage that the cooled heating fluid is used to cool e.g. a building connected to the second heat exchanger. In this manner, the building and the photovoltaic panel(s) may be cooled at the same time by the heat pump.

The method may include running the heat exchanging fluid first through the second heat exchanger, and then through the at least one first heat exchanger before returning it to the heat pump.

In an embodiment of the method according to the invention, relating to at least two photovoltaic panels, in the second mode, the method comprises running heat exchanging fluid through the at least one first heat exchanger of some, but not of all of the at least two photovoltaic panels.

By running the heat exchanging fluid through some but not all of the photovoltaic panels, the heat exchanging fluid may absorb less heat then if it were run through all photovoltaic panels. Accordingly, the temperature of the heat exchanging fluid may be kept at a desirably low level in the second mode, even when the heat pumps capacity is low compared to the amount of heat absorbed if the heat exchanging fluid were run through all photovoltaic panels. The lower temperature achieved in this second mode may be low enough to cool something, such as a house or building, via the second heat exchanger.

As described above, a further mode can be foreseen in which no heat exchanging fluid is fed to any of the photovoltaic panels.

To determine through which or how many first heat exchangers to run the heat exchanging fluid a parameter measurement may take place. More specifically, the method may comprise a step d) of measuring at least one parameter, the at least one parameter being at least one of the following:
a temperature of the heat exchanging fluid at or downstream of the outlet of the heat pump;
a temperature of the heat exchanging fluid at or upstream of the inlet of the at least one first heat exchanger; and
a temperature of the heat exchanging fluid at or downstream of the outlet of the at least one first heat exchanger,
   running the heat exchanging fluid through the at least one first heat exchanger of some, but not of all of the at least two photovoltaic panels based on the at least one parameter.

In another embodiment of the method according to the invention, in a third mode of the method, the method comprises a step e) of bypassing the heat pump by running at least part of the heat exchanging fluid from the at least one first heat exchanger through a third heat exchanger for discharging heat from the heat exchanging fluid.

The method may further include switching between the first, second, third mode, and any other optional further mode.

In another embodiment of the method according to the invention, the method further comprises at least partly powering the heat pump using electricity generated by the at least one photovoltaic panel.

It will be clear for the skilled person that any suitable method can be foreseen for any one or more of the embodiments of the system, as described in the claims or having any one or more features as described above, alone or in any suitable combination.

The invention also relates to a data carrier comprising computer readable instructions which, upon execution by a suitable control means of a system as described above, cause the control means to perform the method as described above.

The invention will be explained further with reference to the attached figures, in which:

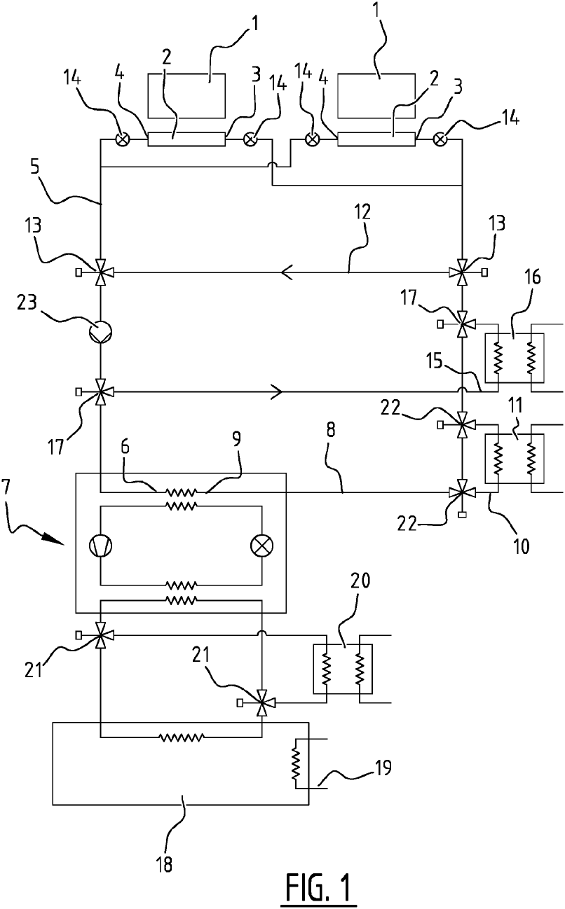

FIG. 1 shows a flow diagram of an exemplary embodiment of the system according to the invention;

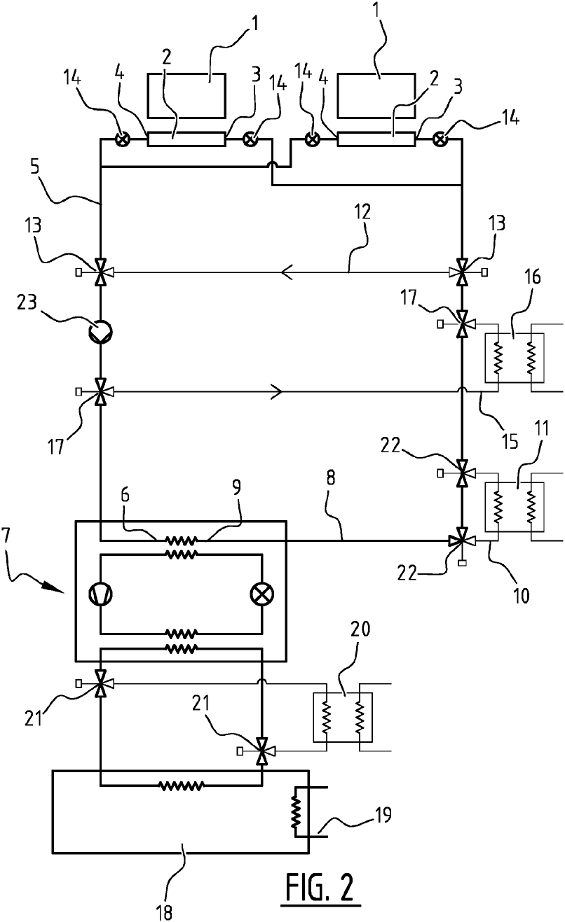

FIGS. 2 — 5 show parts of the flow diagram of FIG. 1 for explaining different working modes of the system;

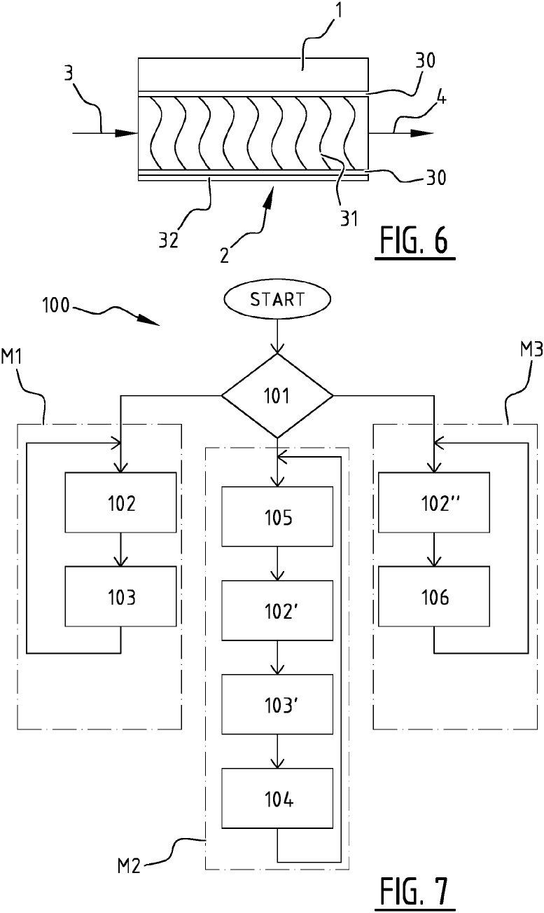

FIG. 6 is a schematic cross section through an exemplary type of a photovoltaic panel with a first heat exchanger as used in the system; and

FIG. 7 is a flow chart of an exemplary embodiment of the method according to the invention.

In the figures, like elements are referred to by like reference numerals.

The system of FIG. 1 comprises in this exemplary embodiment two photovoltaic panels 1. It will be clear for the skilled person that any desired number of photovoltaic panels 1 may be provided. Each photovoltaic panel 1 has a respective first heat exchanger 2 for absorbing heat from said panel 1 and/or from the environment by a heat exchanging fluid. The two first heat exchangers 2 each have an inlet 3 for feeding heat exchanging fluid thereto and an outlet 4 for discharging heat exchanging fluid therefrom. A first conduit 5 connects the outlets 4 of the first heat exchangers 2 to an inlet 6 of a heat pump 7. The heat pump 7 is arranged to either discharge heat from the heat exchanging fluid, thereby cooling the heat exchanging fluid, or to feed heat to the heat exchanging fluid, thereby heating the heat exchanging fluid, dependent on an operating mode of the system, as will be explained further below with respect to FIGS. 2 - 5. A second conduit 8 connects the outlet 9 of the heat pump 7 to the inlets 3 of the first heat exchangers 2. The first conduit 5 and second conduit 8 thus interconnect the heat pump 7 and first heat exchangers 2 for transporting heat exchanging fluid there between. A third conduit 10 is provided that connects the second conduit 8 to a second heat exchanger 11 for absorbing heat by the heat exchanging fluid. Downstream of the second heat exchanger 11 the third conduit 10 connects to the second conduit 8. The second heat exchanger 11 may be a heat exchanger arranged in, at or near a building, and may be used for cooling said building, for instance by having a second heat exchanging fluid that is cooled by the heat exchanging fluid and thereby able to cool the building, for example via an air conditioning system. Two controllable three-way valves 22 are provided between the third conduit 10 and second conduit 8, both upstream and downstream of the second heat exchanger 11. The skilled person however realizes, that a single controllable three-way valve 22 either upstream or downstream of the second heat exchanger 11 could suffice.

In a basic form said system may only comprise the above described features. However, said system may comprise any one or more of the below described features, in any desired combination.

The system according to this exemplary embodiment further comprises a first heat exchanger bypass conduit 12 that connects the second conduit 8 to the first conduit 5 and in this embodiment two controllable three-way valves 13 connecting the first heat exchanger bypass conduit 12 to the second conduit 8 and the first conduit 5. In other embodiments, a single controllable three-way valve 13 may suffice. Via said first heat exchanger bypass conduit 12 some or all of the first heat exchangers 2 may optionally be bypassed, such that it is possible with the system according to this embodiment to feed heat exchanging fluid to all of the first heat exchangers 2, some of the first heat exchangers 2, or none of the first heat exchangers 2.

The system according to this exemplary embodiment further comprises in total four first controllable valves 14, wherein a respective first controllable valve 14 is provided between the outlet 4 of each of the first heat exchangers 2 and the first conduit 5 and between the second conduit 8 and the inlet 3 of each of the first heat exchangers 2. Alternatively a single controllable valve 14 could have been used, either upstream or downstream of each first heat exchanger 1. Moreover, multiple first heat exchangers could be connected to the same one or more controllable valves 14.

The system according to this exemplary embodiment further comprises a fourth conduit 15 connecting the first conduit 5 to a third heat exchanger 16 for discharging heat from the heat exchanging fluid. Said fourth conduit 15 then connects to the second conduit 8 downstream of the third heat exchanger 16. Said third heat exchanger 16 may for example be a heat exchanger of the building and may be arranged for heating tap water by absorbing heat from the heat exchanging fluid, either directly or indirectly via a further heat exchanging fluid. In this exemplary embodiment the fourth conduit 15 is connected to the first conduit 5 via a second controllable three-way valve 17. Another second controllable three-way valve 17 is shown between the fourth conduit 15 and the second conduit 8. Obviously, only one second controllable three-way valve 17 could have been used, at any of the shown locations.

The system according to this exemplary embodiment further comprises a heat buffer 18 for storing heat, wherein said heat pump 7 is arranged to heat the heat buffer 18. The heat buffer 18 may for example comprise a container with an inlet for filling it with a heat buffer fluid and an outlet for discharging heat buffer fluid from the container. The system may further comprise a fifth conduit 19, which is in this embodiment in heat exchanging contact with the heat buffer fluid to heat fluids flowing through the fifth conduit 19. The fifth conduit 19 may for example connect to a heating or tap water system of the building.

The system according to this exemplary embodiment further comprises a fourth heat exchanger 20. Said fourth heat exchanger 20 may be in heat exchanging contact with the heat pump fluid circulating in the heat pump 7. For example, said fourth heat exchanger 20 may be part of a and/or arranged for cooling central heating system fluid, such that said building can be cooled using the central heating system. Two controllable three-way valves 21 are provided such that the flow of heat pump fluid to the heat buffer 18 and/or fourth heat exchanger 20 can be controlled. Alternatively, a single controllable three-way valve 21 could have sufficed, either upstream or downstream of the fourth heat exchanger 20.

The system further comprises a control means (not shown) for controlling a flow of the heat exchanging fluid trough the first conduit and/or the second conduit and/or the third conduit and/or the fourth conduit. Said control means may be arranged to control the controllable valves 14 and/or three-way valves 13, 17, 21, 22.

The system according to this exemplary embodiment further comprises a pump 23 arranged for pumping the heat exchanging fluid through the first conduit 5 and/or second conduit 8 and/or third conduit 10 and/or fourth conduit 15, wherein the control means are operatively connected to the pump 23 for controlling the flow of heat exchanging fluid caused by the pump.

The exemplary system of FIG. 1 can be operated in several operating modi, which will be described with respect to FIGS. 2 — 5. In the FIGS. 2 - 5 the parts of the system in use in that mode are printed in bold lines.

FIG. 2 shows a first mode in which the system can be operated in accordance with the invention. In the first mode at least a part of said cooled heat exchanging fluid that is cooled in the heat pump 7 is fed to the two first heat exchangers 2 via the second conduit 8. As a result of the cooled heat exchanging fluid being fed to the first heat exchangers 2, the two photovoltaic panels 1 are cooled, such that the efficiency of the photovoltaic panel may increase. In this first mode, the heat pump fluid of the heat pump 7 may increase in temperature by absorbing heat from the heat exchanging fluid, which heat pump fluid may be used for heating the buffer fluid in the heat buffer 18. This heated buffer fluid 18 may for example be used for heating a building or tap water of a building via the fifth conduit 19.

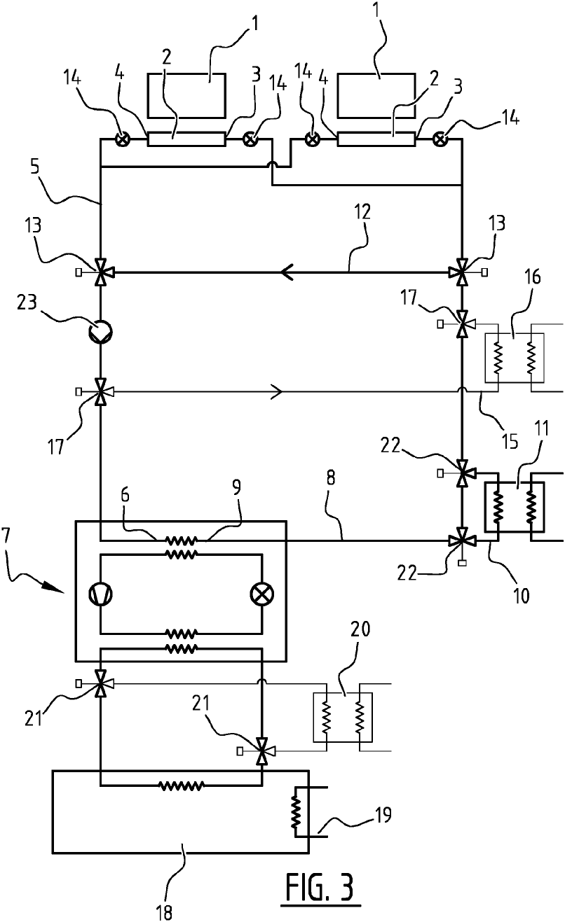

FIG. 3 shows a second mode in which the system can be operated in accordance with the invention. In the second mode the heat exchanging fluid that is cooled by the heat pump 7 first passes the second heat exchanger 11 prior to being fed to the first heat exchangers 2. As a result thereof, the cooled heat exchanging fluid may be used for cooling said building, for instance by having a second heat exchanging fluid that is cooled by the heat exchanging fluid and thereby able to cool the building, for example via an air conditioning system. The heat exchanging fluid increases in temperature in the second heat exchanger 11, but may still be cool enough to cool the at least one photovoltaic panel, such that the efficiency of the photovoltaic panel may increase. Also in this second mode, the heat pump fluid of the heat pump 7 may increase in temperature by absorbing heat from the heat exchanging fluid, which heat pump fluid may be used for heating the buffer fluid in the heat buffer 18. This heated buffer fluid 18 may for example be used for heating a building or tap water of a building via the fifth conduit 19.

In the second mode as shown in FIG. 3, the system is switchable between a first configuration wherein said control means are arranged to feed heat exchanging fluid to all of the first heat exchangers 2 and a second configuration wherein said control means are arranged to feed heat exchanging fluid to some, but not all, of the first heat exchangers 2. If some of the first heat exchangers 2 are bypassed, part of the heat exchanging fluid may be bypassed via the first heat exchanger bypass conduit 12. By feeding heat exchanging fluid to some, but not all, of the first heat exchangers 2 in the second configuration, the temperature increase of the heat exchanging fluid may be limited. For example, the control means may be arranged to feed heat exchanging fluid to some, but not all, of the first heat exchangers 2 and/or to at least partly return to the heat pump 7 via the first heat exchanger bypass conduit 12 based on at least one of the following:
a temperature of the heat exchanging fluid, for example:
   at or downstream of the outlet of the heat pump 7;
   at or upstream of the inlets 3 of the first heat exchangers 2;
   at or downstream of the outlets 4 of the first heat exchangers 2,
the ambient temperature;
a cooling capacity of the heat pump 7;
heat absorption of the heat exchanging fluid in the second heat exchanger 11, and
heat absorption the heat exchanging fluid in the respective first heat exchangers 2.

In FIG. 3 both first heat exchangers 2 and the first heat exchanger bypass conduit 12 are printed in bold lines. It will however be clear for the skilled person that in the first configuration no heat exchanging fluid is transported via the first heat exchanger bypass conduit 12 and that in the second configuration either one of the two first heat exchangers 2 may be bypassed and thus no heat exchanging fluid may be transported therethrough.

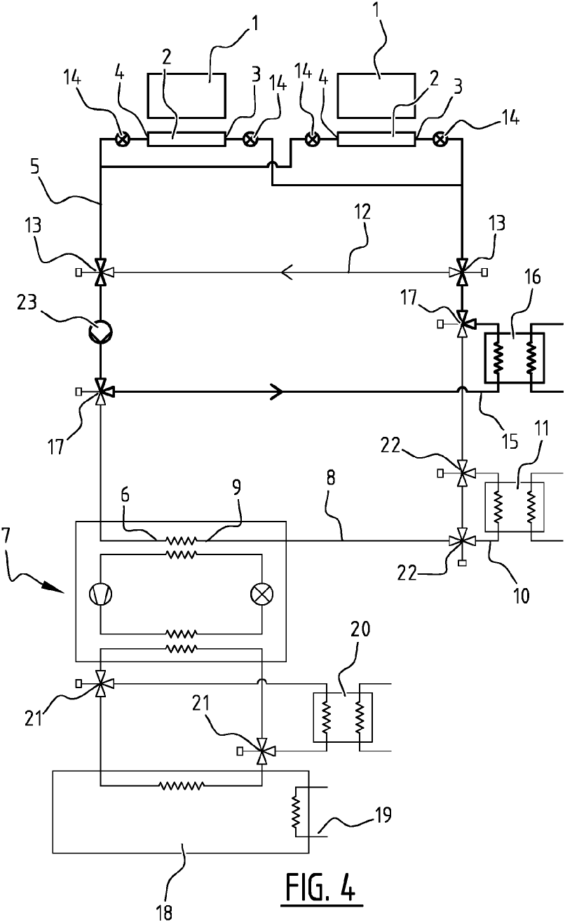

It is noted that it is also possible to bypass both first heat exchangers 2, such that all heat exchanging fluid returns to the heat pump 7 without passing the first heat exchangers 2. Obviously, any other number of heat exchangers could have been chosen. Further, it is possible to limit the flow through one or more of the first heat exchangers 2. The limited flow through the first heat exchangers 2 may then be mixed with flow from the first heat exchanger bypass conduit 12 downstream of the first heat exchangers 2, to obtain a heat exchanging fluid of desirable temperature.FIG. 4 shows a third mode in which the system can be operated in accordance with the invention. In this third mode at least a part of the heat exchanging fluid is fed to the third heat exchanger 16 via the fourth conduit 15. As described above, said third heat exchanger 16 may be a heat exchanger of the building (and/or may be connected to the buffer) and may be arranged for heating tap water by absorbing heat from the heat exchanging fluid, either directly or indirectly via a further heat exchanging fluid. This third mode may be advantageous if the temperature increase of the heat exchanging fluid in the first heat exchangers 2 is large enough for the heat exchanging fluid to heat the tap water via the third heat exchanger 16.

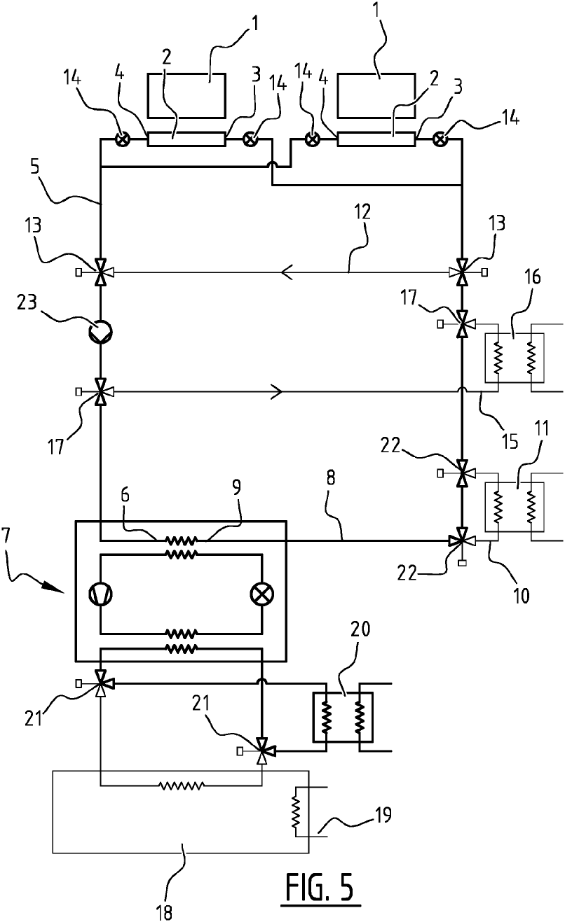

FIG. 5 shows a fourth mode in which the system can be operated in accordance with the invention. In the fourth mode of the system, at least part of the heat exchanging fluid is fed to first heat exchanger 2 via the second conduit 8 and the heat pump 7 is arranged to heat the heat exchanging fluid, thereby discharging heat from a heat pump fluid and thus cooling the heat pump fluid. The cooled heat pump fluid is in this example used for indirectly cooling central heating system fluid in said fourth heat exchanger 20. Alternatively, said heat buffer fluid may be cooled by the cooled heat pump fluid. The heated heat exchanging fluid may be cooled down in the first heat exchanger 2. The fourth mode may for example be advantageous if a building is to be cooled during the night, such that the building may be cooled via the fourth heat exchanger 20, and wherein the heat exchanging fluid is able to discharge its heat via the first heat exchangers 2 which are located outside of the building in the cold night and thereby able to cool the heat exchanging fluid.

The system may be switched between any of the above described operating modi, or any other, not described operating mode.

FIG. 6 shows an exemplary embodiment of the photovoltaic panel 1 and the first heat exchanger 2 thereof. This FIG. 6 shows that the first heat exchanger 2 may comprise a three dimensional fabric, the three dimensional fabric comprising two woven or knitted main surfaces 30 which extend substantially parallel to each other at a distance from each other, wherein the main surfaces are interconnected by a plurality of piles 31, wherein said plurality of piles defines a plurality of flow paths therebetween between the inlet 3 and outlet 4 of the first heat exchanger 2. One of the main surfaces 30 may be in direct contact with the photovoltaic panel 1, such that the panel 1 and first heat exchanger 2 are in good heat exchanging contact. The other main surface 30 may comprise a fluid impermeable coating 32 applied thereto. The coating 32 may alternatively be a fluid impermeable layer. Optionally said three dimensional fabric may be arranged in a frame (not shown).

FIG. 7 shows in a flowchart a method 100 for absorbing heat from at least one photovoltaic panel and/or from the environment by a heat exchanging fluid, the photovoltaic panel having at least one first heat exchanger. The flowchart includes a step 101 of switching between a first mode M1, a second mode M2 and a third mode M3. Although the switching step 101 is shown to occur only once, practically the switching step 101 may be performed multiple times in order to switch between the first, second and third modes M1, M2, M3. After having performed any one or more of the modes M1, M2, M3 of the method for a desired amount of time, the method may be stopped or another mode may be selected. The first mode includes a first step 102 of running the heat exchanging fluid through the at least one first heat exchanger, so that it absorbs heat from its respective photovoltaic panel and/or from the environment, and a second step 103 of running the heat exchanging fluid through a heat pump, and discharging heat from the heat exchanging fluid by the heat pump, thereby cooling the heat exchanging fluid. According to the invention, in the first mode M1, these steps 102, 103 are repeated and/or continuously conducted, possibly until another mode M2, M3 is selected. The second mode M2 includes steps 102′ and 103′ which correspond to steps 102 and 103 of the first mode respectively, unless state otherwise. The second mode further comprises an additional step 104 of running the cooled heat exchanging fluid through a second heat exchanger. In an example embodiment of the method described in FIG. 7, step 102′ comprises running heat exchanging fluid through the at least one first heat exchanger of some, but not of all of the at least two photovoltaic panels. The method 100 further includes a measuring step 105, which is optional, of measuring at least one parameter, the at least one parameter being at least one of the following a temperature of the heat exchanging fluid at or downstream of the outlet of the heat pump; a temperature of the heat exchanging fluid at or upstream of the inlet of the at least one first heat exchanger; and a temperature of the heat exchanging fluid at or downstream of the outlet of the at least one first heat exchanger. During the step 102′ of running the heat exchanging fluid through the at least one first heat exchanger, running the heat exchanging fluid through the at least one first heat exchanger of some, but not of all of the at least two photovoltaic panels is based on the at least one parameter measured in the measuring step 105. The third mode M3 comprises a first step 102″ equal to step 102 of the first mode M1 unless stated otherwise. The steps 105, 102′, 103′, 104 of the second mode M2 are repeated and/or continuously conducted until anther mode is selected. The third mode M3 further comprises a step 106 of bypassing the heat pump by running at least part of the heat exchanging fluid from the at least one first heat exchanger through a third heat exchanger for discharging heat from the heat exchanging fluid. The steps 102″, 106 of the third mode M3 are repeated and/or continuously conducted until another mode is selected.

Although the invention has been described hereabove with reference to a number of specific examples and embodiments, the invention is not limited thereto. Instead, the invention also covers the subject matter defined by the claims, which now follow.

For example, it will be clear for the skilled person that the number and/or location of controllable valves and/or three-way valves may be chosen as desired. For example, instead of four first controllable valves 14, two first controllable valves 14 may be provided, either upstream or downstream of a said first heat exchanger 2. Also multiple first heat exchangers 2 can be connected to the same one or more controllable valves 14.

1. A system, comprising:
at least one photovoltaic panel having at least one first heat exchanger for absorbing heat from said panel and/or from the environment by a heat exchanging fluid, said at least one first heat exchanger having an inlet for feeding heat exchanging fluid thereto and an outlet for discharging heat exchanging fluid therefrom;
a heat pump having an inlet connected to the outlet of the at least one first heat exchanger for receiving heat exchanging fluid from the outlet of the at least one first heat exchanger via a first conduit and an outlet connected to the inlet of the at least one first heat exchanger for feeding heat exchanging fluid to the at least one first heat exchanger via a second conduit;
a third conduit connecting the second conduit to a second heat exchanger for absorbing heat by the heat exchanging fluid; and
a control means for controlling a flow of the heat exchanging fluid trough the first conduit and/or the second conduit and/or the third conduit,
wherein said heat pump is arranged to discharge heat from the heat exchanging fluid, thereby cooling the heat exchanging fluid, the system having at least the following operating modes:
a first mode wherein at least a part of said cooled heat exchanging fluid is fed to the at least one first heat exchanger via the second conduit; and
a second mode, wherein at least a part of said cooled heat exchanging fluid is fed to the second heat exchanger via said third conduit and then fed to the inlet of the at least one first heat exchanger.

2. The system according to claim 1, wherein said system comprises at least two of said photovoltaic panels, each photovoltaic panel having a said first heat exchanger having a said inlet and a said outlet, and wherein, at least in the second mode of the system, the system is switchable between a first configuration wherein said control means are arranged to feed heat exchanging fluid to all of the first heat exchangers and a second configuration wherein said control means are arranged to feed heat exchanging fluid to some, but not all, of the first heat exchangers.

3. The system according to claim 1, wherein said system comprises a first heat exchanger bypass conduit that connects the second conduit to the first conduit and at least one controllable three-way valve connecting the first heat exchanger bypass conduit to the second conduit and/or the first conduit.

4. The system according to claim 2, wherein said control means are arranged to feed heat exchanging fluid to some, but not all, of the first heat exchangers and/or to at least partly return to the heat pump via the first heat exchanger bypass conduit based on at least one of the following:
a temperature of the heat exchanging fluid:
at or downstream of the outlet of the heat pump;
at or upstream of the inlet of the at least one first heat exchanger;
at or downstream of the outlet of the at least one first heat exchanger,
the ambient temperature.

5. The system according to claim 2, wherein said control means are arranged to feed heat exchanging fluid to some, but not all, of the first heat exchangers and/or to at least partly return to the heat pump via the first heat exchanger bypass conduit based on at least one of the following:
a cooling capacity of the heat pump;
heat absorption of the heat exchanging fluid in the second heat exchanger, and
heat absorption the heat exchanging fluid in the respective first heat exchangers.

6. The system according to claim 2, further comprising at least one first controllable valve between the outlet of each one or multiple of the first heat exchangers and the first conduit and/or between the second conduit and the inlet of each of the one or multiple first heat exchangers, the first controllable valves being operatively connected to the control means, wherein the control means are arranged for adjusting the first controllable valves independently from each other between an open and a closed position to control the flow of heat exchanging fluid through the respective one or multiple first heat exchangers.

7. The system according to claim 1, further comprising a fourth conduit connecting the first conduit to a third heat exchanger for discharging heat from the heat exchanging fluid, wherein at least in the second mode substantially no heat exchanging fluid is fed to the third heat exchanger via the fourth conduit, and in a third mode of the system at least a part of the heat exchanging fluid is fed to the third heat exchanger via the fourth conduit,
wherein the fourth conduit is connected to the first conduit via a second controllable three-way valve, upstream and/or downstream of the third heat exchanger, wherein the second controllable three-way valve is operatively connected to the control means, wherein the control means are arranged for adjusting the second controllable three-way valve between an open and a closed position to control the flow of heat exchanging fluid through the fourth conduit.

8. The system according to claim 1, wherein said heat pump is configured to be at least partly powered by electrical energy generated by said at least one photovoltaic panel.

9. The system according to claim 1, further comprising a heat buffer for storing heat, wherein said heat pump is arranged to heat the heat buffer.

10. The system according to claim 9, wherein the heat buffer comprises a container with an inlet for filling it with a heat buffer fluid and an outlet for discharging heat buffer fluid from the container.

11. The system according to claim 9, wherein the system further comprises a fifth conduit, connected to the outlet of the heat buffer for letting out heated heat buffer fluid, or in heat exchanging contact with the heat buffer fluid to heat fluids flowing through the fifth conduit.

12. The system according to claim 1, wherein in a fourth mode of the system, at least part of the heat exchanging fluid is fed to the at least one first heat exchanger via the second conduit and the heat pump is arranged to heat the heat exchanging fluid, thereby discharging heat from a heat pump fluid and thus cooling the heat pump fluid, and at least one of the following:
a fourth heat exchanger is provided, wherein said cooled heat pump fluid is arranged for cooling central heating system fluid in said fourth heat exchanger, and
a or said heat buffer fluid is cooled by the cooled heat pump fluid.

13. The system according to claim 1, further comprising at least one pump arranged for pumping the heat exchanging fluid through the first and/or second and/or third and/or fourth conduit, wherein the control means are operatively connected to the pump for controlling the flow of heat exchanging fluid caused by the pump.

14. The system according to claim 1, wherein the at least one first heat exchanger comprises a three dimensional fabric, the three dimensional fabric comprising two woven or knitted main surfaces which extend substantially parallel to each other at a distance from each other, wherein the main surfaces are interconnected by a plurality of piles, wherein said plurality of piles defines a plurality of flow paths therebetween between the inlet and outlet of the at least one first heat exchanger.

15. A method for absorbing heat from at least one photovoltaic panel and/or from the environment by a heat exchanging fluid, the photovoltaic panel having at least one first heat exchanger, the method comprising:
a) running the heat exchanging fluid through the at least one first heat exchanger, so that it absorbs heat from its respective photovoltaic panel and/or from the environment; and
b) running the heat exchanging fluid through a heat pump, and discharging heat from the heat exchanging fluid by the heat pump, thereby cooling the heat exchanging fluid, and
c) switching between:
a first mode of the method, wherein steps a) and b) are repeated and/or continuously conducted; and
a second mode of the method, wherein steps a) and b) are repeated and/or continuously conducted and the method further comprises running the cooled heat exchanging fluid through a second heat exchanger.

16. The method according to claim 15 wherein the at least one photovoltaic panel comprises at least two photovoltaic panels, wherein in the second mode of the method, the method comprises running heat exchanging fluid through the at least one first heat exchanger of some, but not of all of the at least two photovoltaic panels.

17. The method according to claim 15, further comprising:
d) measuring at least one parameter, the at least one parameter being at least one of the following:
a temperature of the heat exchanging fluid at or downstream of the outlet of the heat pump;
a temperature of the heat exchanging fluid at or upstream of the inlet of the at least one first heat exchanger; and
a temperature of the heat exchanging fluid at or downstream of the outlet of the at least one first heat exchanger,
running the heat exchanging fluid through the at least one first heat exchanger of some, but not of all of the at least two photovoltaic panels based on the at least one parameter.

18. The method according to claim 15, wherein in a third mode of the method the method comprises:
e) bypassing the heat pump by running at least part of the heat exchanging fluid from the at least one first heat exchanger through a third heat exchanger for discharging heat from the heat exchanging fluid.

19. The method according to claim 15, further comprising at least partly powering the heat pump using electricity generated by the at least one photovoltaic panel.

20. A data carrier comprising instructions which, upon execution by a suitable control means of a system according to claim 1, cause the control means to perform the method comprising:
a) running the heat exchanging fluid through the at least one first heat exchanger, so that it absorbs heat from its respective photovoltaic panel and/or from the environment; and
b) running the heat exchanging fluid through a heat pump, and discharging heat from the heat exchanging fluid by the heat pump, thereby cooling the heat exchanging fluid, and
c) switching between:
a first mode of the method, wherein steps a) and b) are repeated and/or continuously conducted; and
a second mode of the method, wherein steps a) and b) are repeated and/or continuously conducted and the method further comprises running the cooled heat exchanging fluid through a second heat exchanger.
